(19) United States
(12) Patent Application Publication
(10) Pub. No.: US 2006/0003067 A1
(43) Pub. Date: Jan. 5, 2006

(54) Shielded self-stirring crackling cooker

(76) Inventor: Robert Dennis Buchanan, Lake Charles, LA (US)

Correspondence Address: Robert Dennis Buchanan, 4325 Hearth RD., L ake Charles, LA, 70605, US

(21) Appl. No.: 10/811,111

(22) Filed: Jun. 30, 2004

(51) Int. Cl. A23L 1/00

(52) U.S. Cl. 426/519

(57) ABSTRACT

My invention, the Shielded Self-Stirring Crackling Cooker, was designed to improve the traditional method of cooking cracklings, which involves a cast iron pot over an open heat source and manual stirring. The shield of my invention, which surrounds the cast iron pot, minimizes hot spots and uneven cooking. At the same time, it reduces the amount of heat required. The self-stirring mechanism provides consistent and constant movement of the cracklings during the entire cooking process, preventing burning and breakage and eliminating the need for manual stirring and shortening the cooking time.

### BACKGROUND OF INVENTION

Cracklings (or cracklins) are the square cut pieces of pig skin cooked in their own fat in a cast iron pot, over a wood fire or a gas burner. They are traditionally cooked manually with a metal paddle (or shovel) to stir the pieces, and keep them from sticking and burning on the bottom or sides of the pot. This process subjects the person doing the cooking to all the heat and/or flames coming off the sides of the pot while constantly having to stir, and creates a hot bottom on the pot, with the sides being less heated. Stirring by hand with a metal paddle or shovel cannot be done evenly, resulting in burnt and broken cracklings.

I, Robert Dennis Buchanan, endeavored to improve this crackling cooking process at the request of a friend who cooks and sells cracklings as well as barbequed meats of all kinds. I researched the cooking process by observing actual cooking in the traditional manner. I then applied my experience as a steel fabricator/millwright to build a working prototype. All of the parts of the Shielded Self-Stirring Crackling Cooker are made of mild carbon steel and welded together, except where bolted as noted. The Shielded Self-Stirring Crackling Cooker eliminates all of the problems associated with the traditional manual method and, at the same time, reduces fuel consumption and cooking time.

### DETAILED DESCRIPTION

This invention incorporates a shield that supports and encloses a traditional 24″ cast iron pot, used to cook cracklings. The bottom section of the shield houses the gas burner, directing the flame and heat to the bottom of the pot, and the upper section of the shield closely covers the sides of the pot, retaining heat evenly over more cooking surface, thus requiring less fuel to heat the entire pot. The cast iron pot is supported by a shelf between the two sections.

The self-stirring is accomplished by a 2 RPM motor, mounted on a swing arm that is raised and lowered manually by the user, with a passive locking mechanism. This locking device allows the user to lift and swing the motor mount arm up and out of the way when emptying the pot and down into a fixed position when cooking. The 2 RPM motor turns a three arm rod stirrer, which prevents the cracklings from sticking and burning on the bottom and sides of the cast iron pot, in the same manner as manually employed with a metal paddle during the traditional cooking process.

### DESCRIPTION OF DRAWINGS

FIG. 1 is a top and side view of the invention, showing all detail numbers for each specific part of the invention and the figure number each detail is listed under.

FIG. 2 shows detail #1, the upper locking retainer on the pipe stand, which works with detail #2, the upper locking retainer on the swing arm slide to passively (no moving parts) lock the swing arm in the upper position. Detail #2 also shows the lower stirring position retainer on the swing arm slide.

FIG. 3 shows detail #3, the lower stirring position receiver, which works with the lower stirring position retainer (detail #2 of FIG. 2) to position and lock the swing arm slide in the lower stirring position.

FIG. 3 also shows detail #4, the pipe stand to shield attachment, which secures the pipe stand with a bolted connection to the shield structure.

FIG. 4 shows detail #5, a bolted connection of the pipe stand to the bottom of the shield structure.

FIG. 4 also shows detail #6, the burner support plate which is located inside the bottom section of the shield.

FIG. 5 shows detail #7, the swing arm motor mount as attached to the swing arm.

FIG. 5 also shows detail #8, the connection of the self-stirring rod to the motor shaft.

FIG. 6 shows detail #9, the configuration of the self-stirring rod.

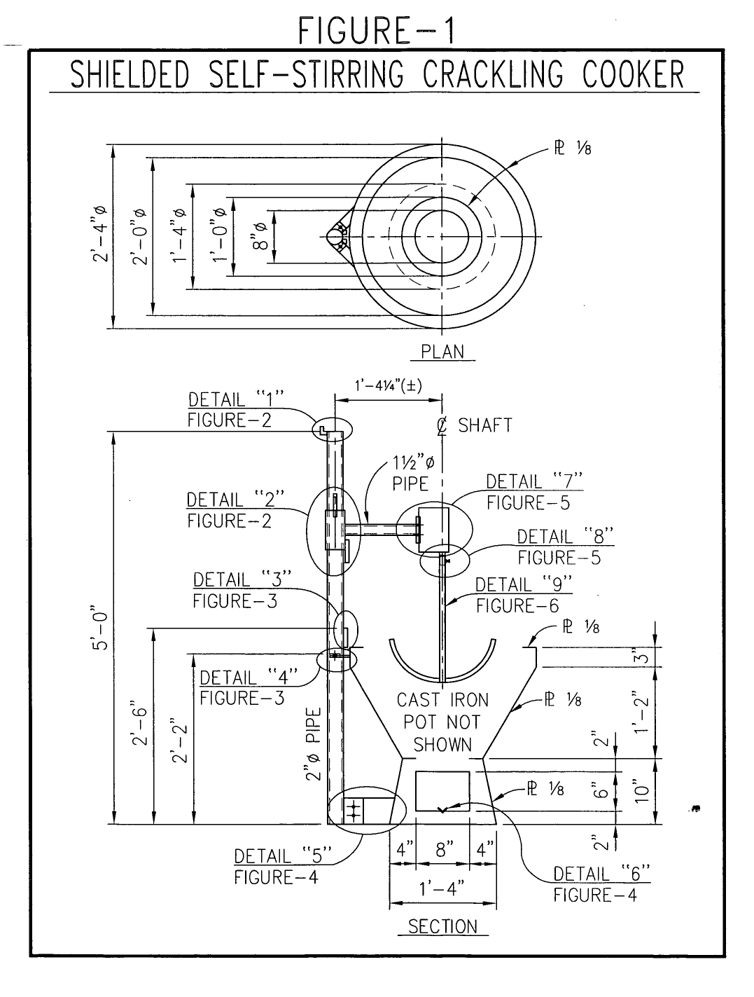

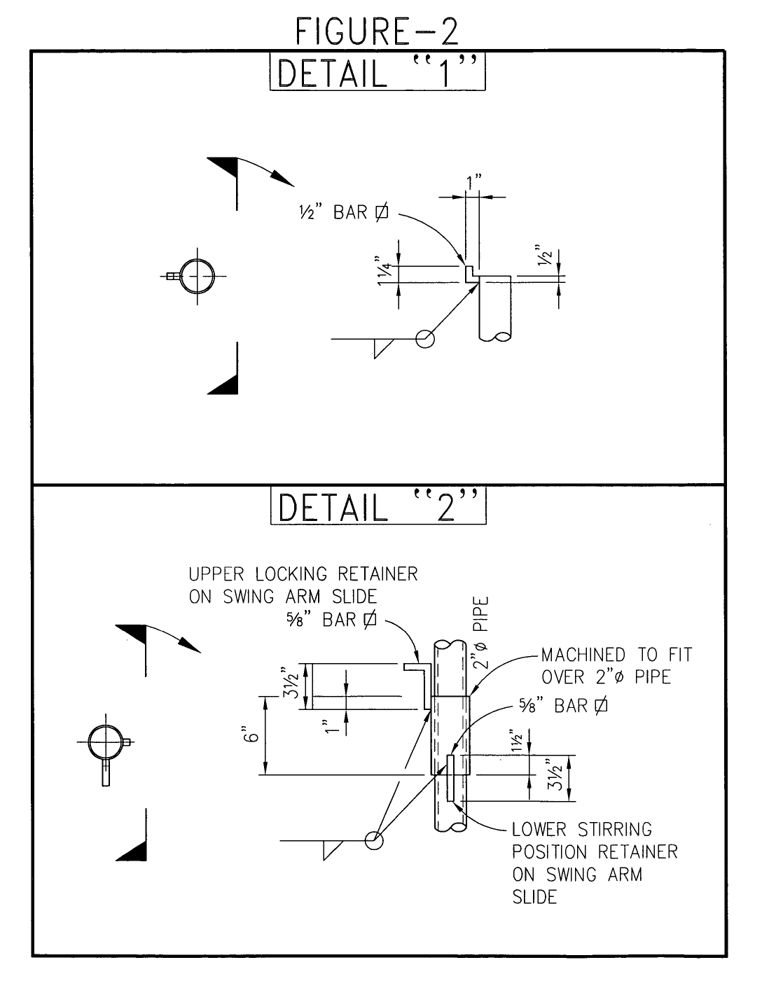

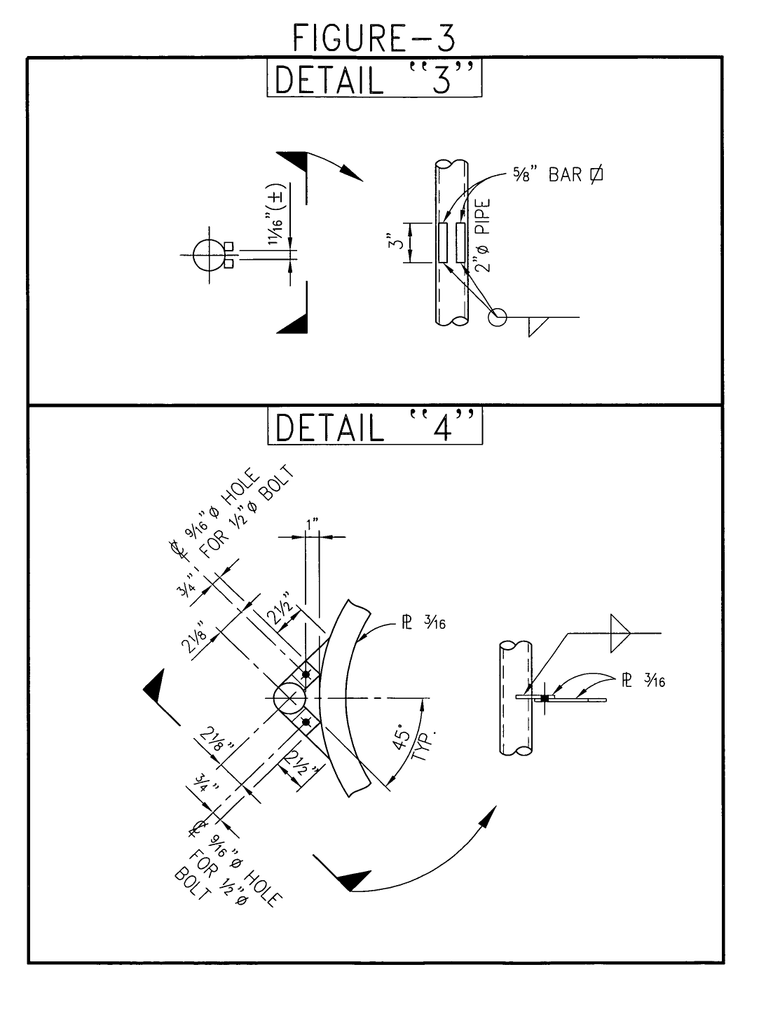

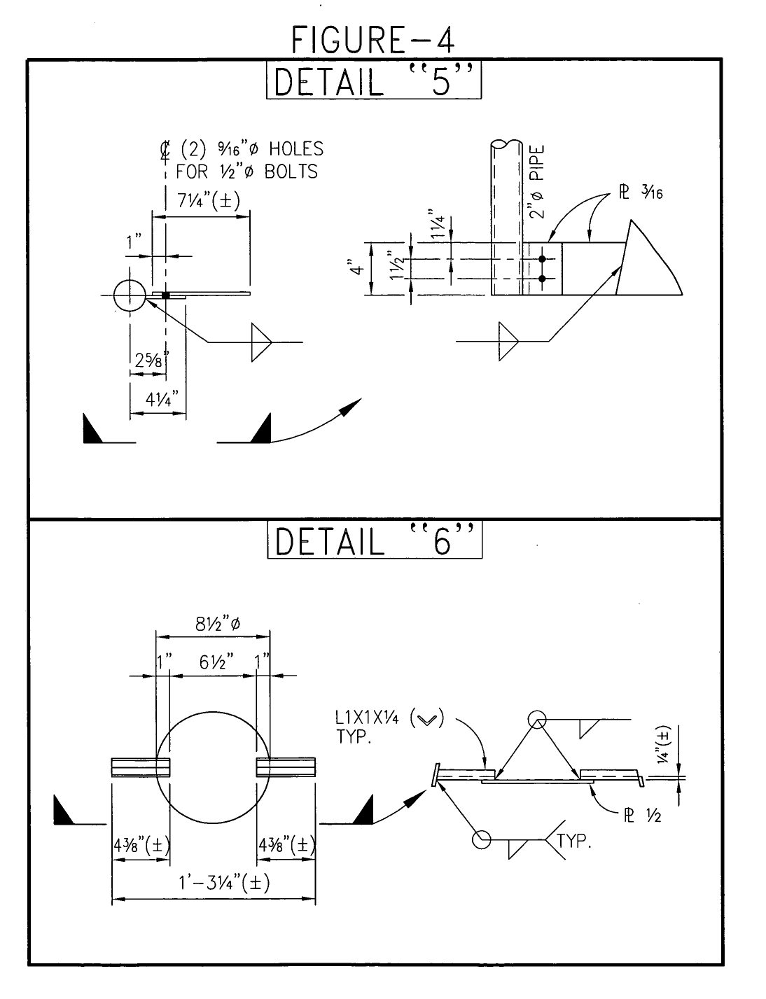

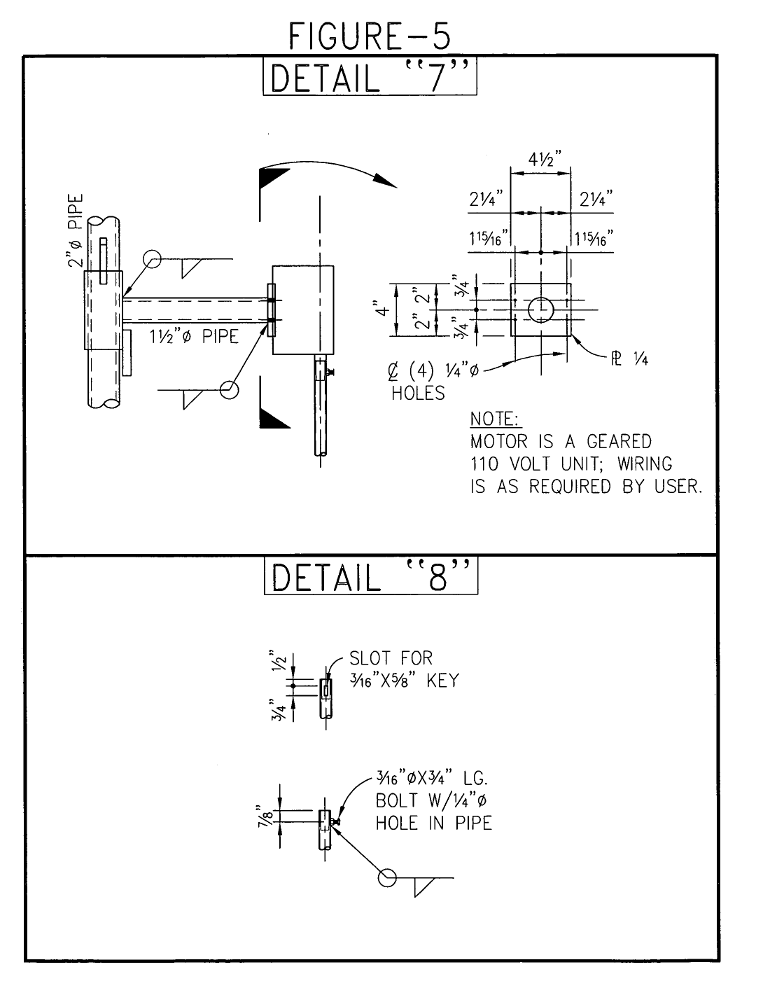

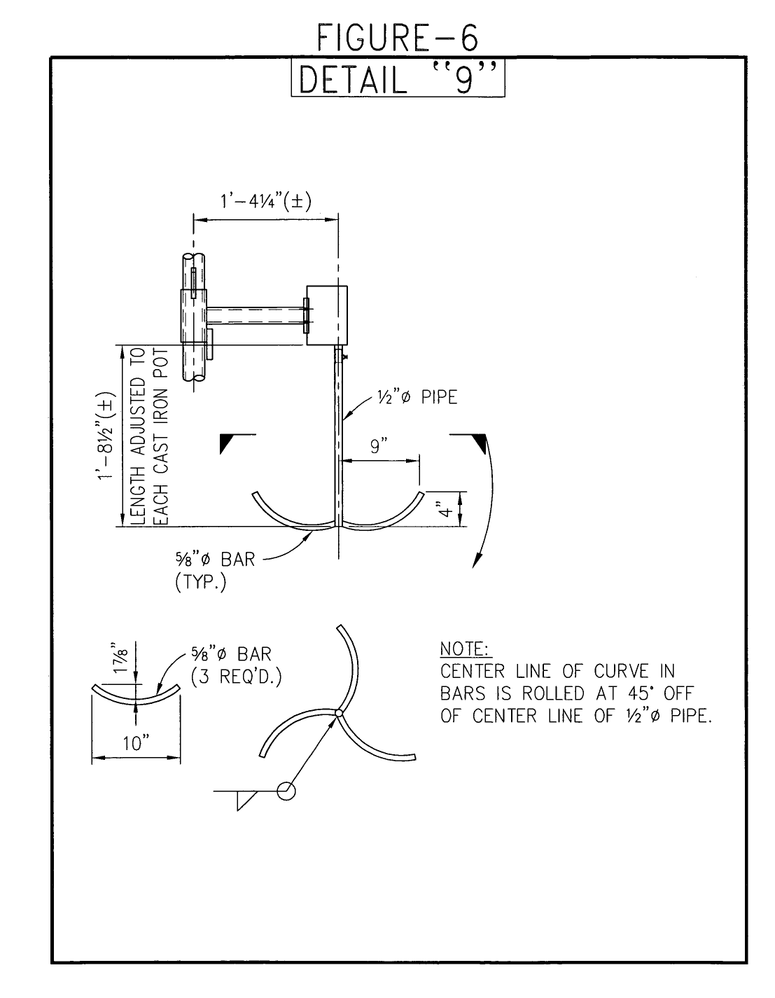

### DESCRIPTION OF USE

To cook with the shielded self-stirring crackling cooker, a 24″ cast iron pot is placed into the upper section of the shield with its feet resting on the horizontal steel plate shelf inside the shield. The slide arm is lowered into the cooking position, centering the self-stirring rod in the pot, with its' three curved arms closely confirming to the curvature of the pots bottom. A gas burner with a pipe extension long enough to reach from the center of the burner support plate to at least 6″ outside the lower section is placed on the burner support plate and lit at a low to medium flame.

One or two quarts of lard may be added to the pot at this time, if desired. Next, 40 pounds of cut crackling pieces are added to the pot, and the motor is turned on. The cooking process is now automatic. The process may be stopped by turning off the motor periodically to check the condition of the cracklings, as different factors (size of crackling pieces and amount of heat) will determine how long the cracklings need to cook. Generally, crackling pieces cut into approximately 1½″ cubes will take between 35 and 40 minutes to cook at a low to medium flame. When the cracklings are cooked, the gas burner is turned off and the slide arm is lifted. When the self-stirring rod and its curved arms are above the pot, the swing arm is turned to the side and lifted so that the upper locking retainer on the slide arm goes over and rests on the upper locking retainer on the pipe stand top. The vertically raised portion of the upper locking retainer on the pipe stand stops the upper locking retainer on the slide arm from moving back, thus prevention the swing arm from being accidentally bumped and made to fall. At this time, the cracklings are removed from the pot with a long-handled strainer for draining.

1. What I claim as my invention is the shielded self-stirring crackling cooker, which eliminates all of the problems associated with the traditional manual method and, at the same time, reduces fuel consumption and cooking time.

2. I claim that my design of the shield retains heat evenly over the cast iron pot, eliminating hot spots and requiring less fuel to accomplish the cooking process.

3. I claim that my design for self-stirring provides a better cooking process with consistent and constant movement of the crackling pieces, that that this self-stirring greatly recues breakage and burnage associated with manual stirring.
